(19) United States
(12) Patent Application Publication
(10) Pub. No.: US 2015/0206262 A1
(43) Pub. Date: Jul. 23, 2015

(54) SYSTEMS AND METHODS FOR DETERMINING AND COMMUNICATING NOTIFICATION MESSAGES TO A POINT OF SALE DEVICE

(71) Applicant: MCKESSON FINANCIAL HOLDINGS, Hamilton (BM)

(72) Inventors: Roger G. Pinsonneault, Alpharetta, GA (US); Patricia A. daCosta, Atlanta, GA (US)

(73) Assignee: MCKESSON FINANCIAL HOLDINGS, Hamilton (BM)

(21) Appl. No.: 14/231,124

(22) Filed: Mar. 31, 2014

Related U.S. Application Data
(63) Continuation-in-part of application No. 12/570,886, filed on Sep. 30, 2009.

(51) Int. Cl. G06Q 50/22; G06Q 20/20

(52) U.S. Cl. CPC G06Q 50/22; G06Q 20/202

(57) ABSTRACT

Systems and methods are provided for determining and communicating notification messages which may be available for a patient, as part of the processing of a healthcare transaction. A healthcare claim transaction, such as a prescription claim request, may be received by the service provider computer from a pharmacy management system. The service provider computer may determine if an a notification message is available for the patient and if a patient response to an available notification message has been transmitted to the service provider prior to the service provider computer receiving the healthcare claim transaction. The service provider computer may receive an approved adjudicated response and generate a notification corresponding to the available notification message for the patient. The service provider computer may receive a patient response to the message and may capture the patient response for use as a part of the processing of other healthcare transactions.

### RELATED APPLICATIONS

This application is a continuation-in-part of and claims priority under 35 U.S.C. §120 to U.S. patent application Ser. No. 12/570,886, filed Sep. 30, 2009, and titled “SYSTEMS AND METHODS FOR VERIFYING RECEIPT OF MESSAGES AT POINT OF SALE,” the entire contents of which is hereby incorporated herein by reference in its entirety for all purposes.

### TECHNICAL FIELD

Aspects of the disclosure relate generally to healthcare transactions and more particularly to systems and methods for determining and communicating notification messages, such as a reminder to receive a vaccination or other patient intervention service, that may be available for a patient, as part of the processing of a healthcare transaction.

### BACKGROUND

Providing pharmacies, pharmacy ownership, and service providers a systemized method for processing and tracking communications at the patient level can be a challenge with today's pharmacy computer systems. For example, in the current pharmacy environment, a pharmacy typically does not have a system for reminding a pharmacist and/or a pharmacy employee to speak to a specific patient or patient caregiver. Rather, the pharmacist and/or pharmacy employee must rely on notes made on the prescription bag and/or general information integrated on a prescription label. Furthermore, should a pharmacy recognize that a note exists and relay that information to the patient, the pharmacy may not have the means to capture the patient dialogue, and subsequently the communication to the patient may not be tracked.

### BRIEF DESCRIPTION OF THE DRAWINGS

Reference will now be made to the accompanying drawings, which are not necessarily drawn to scale, and wherein:

FIG. 1 illustrates an example system for facilitating, among other things, determining and communicating notification messages, such as a reminder for to receive a vaccination or other patient intervention service, that may be available for a patient as part of the processing of a healthcare transaction, according to one exemplary embodiment of the disclosure.

FIG. 2 illustrates an example block diagram for accessing, determining, and/or communicating a patient reminder and/or patient services messages that may be available for a patient as part of the processing of a healthcare transaction, according to an example embodiment of the disclosure.

FIGS. 3A-E illustrate a flow chart of an example method for accessing, determining, and/or communicating a patient reminder and/or patient services message that may be available for a patient as part of the processing of a healthcare transaction submitted by a pharmacy via a pharmacy management system, according to an example embodiment of the disclosure.

### DETAILED DESCRIPTION OF EXEMPLARY EMBODIMENTS

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Exemplary embodiments described herein include systems and methods for determining and communicating notification messages, such as a reminder for a vaccination, or other patient intervention service that may be available for a patient as part of the processing of a healthcare transaction. In this regard, the available notification message may be determined as a part of the processing of a healthcare transaction, such as a predetermination of benefits transaction, healthcare claim transaction, prescription claim or billing request, healthcare order transaction, or e-prescription transaction (i.e., electronic prescription order transaction, e-script, or e-prescription). In some example implementations, a prescription claim request may be communicated from a pharmacy management system to a service provider computer. In one example, the prescription claim request may be a National Council for Prescription Drug Programs (NCPDP) formatted prescription claim request. The service provider computer may deliver the prescription claim request to a third-party computer, such as a claims processor computer, for adjudication. The service provider computer can receive an adjudicated response from the claims processor computer, which can include an indication of an approved (or paid) claim or a denied claim. If the adjudicated response indicates a paid or approved claim, the service provider computer can further generate a notification message that includes a patient reminder or notification of a service available to the patient identified in the prescription claim request.

In certain example embodiments, the notification message may be integrated with an approved adjudicated response and may be communicated to the pharmacy management system. The pharmacy management system may deliver the notification message to a point of sale system communicably coupled to the pharmacy management system for presentation to the patient upon pick-up of a filled prescription. In certain other example embodiments, the service provider computer may generate an outbound point of sale register request transaction that includes the information corresponding to the notification message. The service provider computer may communicate the outbound point of sale register request transaction to the point of sale system, and communicate the approved adjudicated response to the pharmacy management system.

In certain example embodiments, receipt of the notification message may be verified at the point of sale system. For example, once the POS system has received the message, the POS system may present the message to an operator of the POS system during a checkout transaction in which the patient is picking up the product. The operator may perform one or more actions requested by the presented message. In order to complete the checkout transaction at the POS system, the operator may provide to the POS system, confirmation of receipt of the message and/or completion of one or more actions requested by the presented message.

The operator of the POS system may also capture a patient response to the notification message and communicate the patient response to the service provider computer. The service provider computer may capture a message date, a message type, and a message type response and facilitate storage of the captured information in an identified patient information file and/or a notification file. The service provider computer may also utilize the captured information to determine whether a similar notification message should be generated and communicated to the pharmacy management system and/or the POS system during the processing of subsequent healthcare transactions.

The term “product,” and its pluralized form, as used herein, is intended to refer to any good, including a drug, medication, formulation, or other substance. Additionally, it is appreciated that a “drug” may be referred to herein for simplicity as being the subject of a healthcare transaction; however, a healthcare transaction may be for any product, good, or service, and is not intended to be limited to drugs.

System Overview

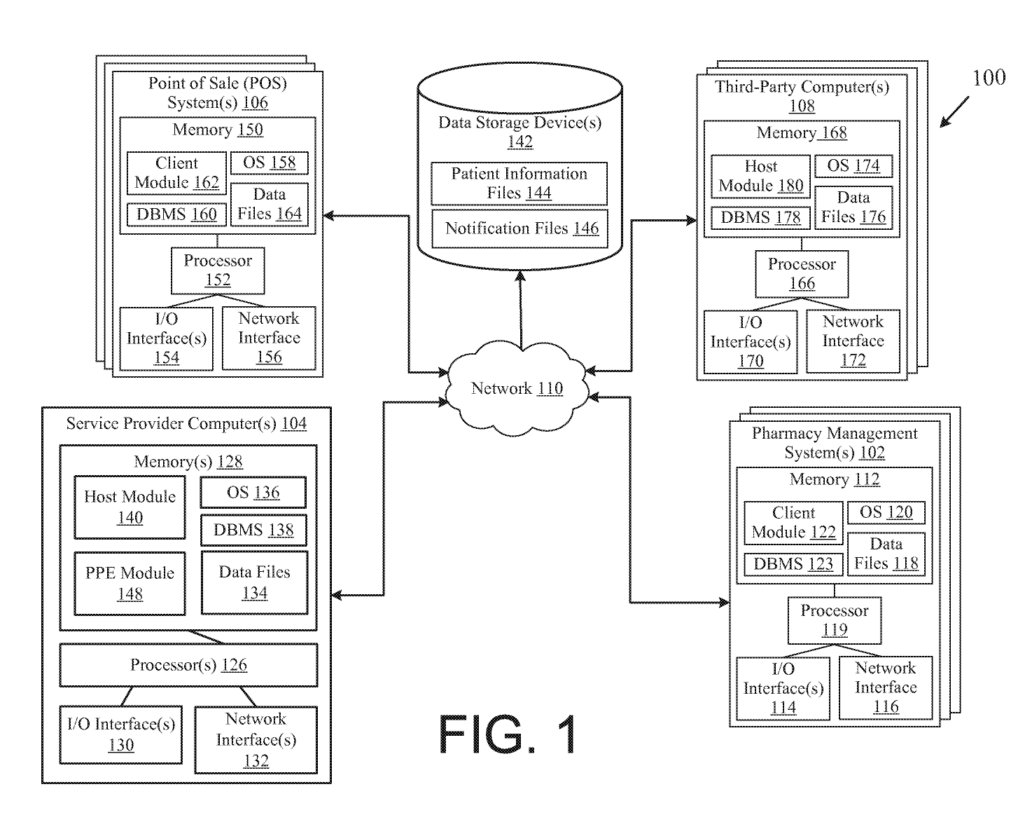

FIG. 1 illustrates an example system 100 for facilitating, among other things, determining and communicating notification messages, such as a reminder to receive a vaccination, such as an influenza vaccination, or other patient intervention service, for a patient as part of the processing of a healthcare transaction, according to one example embodiment of the disclosure. For example, a notification may include, without limitation, a notification to remind the patient and/or patient caregiver that an electronic coupon was applied to the prescription, a notification to remind the patient and/or patient caregiver of an opportunity for a medication intervention, a notification to remind the patient to obtain their annual influenza vaccine or any other type of vaccine that is due or available, a notification to the pharmacy clerk to explain the need for patient consent, and/or a request to capture a patient or patient caregivers identification information (e.g., a driver's license) at the time of purchase. As shown in FIG. 1, the system 100 may include one or more pharmacy management systems 102, one or more service provider computers 104, one or more point of sale (POS) systems 106, and/or one or more third-party computers 108 (e.g., claims processor computers). As desired, each of the pharmacy management system 102, service provider computer 104, POS system 106, and/or third-party computer 108 may include one or more processing devices that may be configured for accessing and reading associated computer-readable media having stored data thereon and/or computer-executable instructions for implementing various embodiments of the disclosure. Each of the pharmacy management system 102, the service provider computer 104, the POS system 106, and the third-party computer 108 may be in direct communication with each other and/or in communication via a network 110.

Although various computers are illustrated in, and described with reference to, FIG. 1, it is appreciated that each of these computers is can be associated with a respective entity. For example, the pharmacy management system 102 may be associated with (e.g., located within and/or providing primary computing services for) and/or operated by a pharmacy. The POS system 106 may be associated with (e.g., located within) and/or operated by a retailer, which could be the same pharmacy or any other retailer. The service provider computer 104 may be associated with (e.g., located within and/or providing computing services for) and/or operated by a service provider. The third-party computer 108 may be associated with (e.g., located within and/or providing computing services for) third-party computer, such as a claims processor (e.g., a pharmacy benefits manager (PBM), an eligibility verification adjudicator, a healthcare insurance company, a Medicare payor, Medicaid payor, another governmental insurance payor, another third-party insurance payor or another third-party payer).

Moreover, multiple entities of the same type may participate, each associated with and/or operating one or more computers. For example, multiple pharmacies, retailers, service providers, and claims processors may participate in these processes, each associated with and/or operating one or more respective pharmacy management systems, POS systems, service provider computers, and/or other third-party computers.

Generally, network devices and systems, including one or more pharmacy management systems 102, service provider computers 104, POS systems 106, and/or third-party computers 108 may include or otherwise be associated with suitable hardware and/or software for transmitting and receiving data and/or computer-executable instructions over one or more communications links or networks. These network devices and systems may also include any number of processors for processing data and executing computer-executable instructions, as well as other internal and peripheral components currently known in the art or which may be developed in the future. Further, these network devices and systems may include or be in communication with any number of suitable memory devices operable to store data and/or computer-executable instructions. By executing computer executable instructions, each of the network devices may form a special-purpose computer or particular machine. As used herein, the term “computer-readable medium” describes any medium for storing computer-executable instructions.

The pharmacy management system 102, the service provider computer 104, the POS system 106, and the third-party computer 108 may each be one or more processor-driven devices, such as, but not limited to, a server computer, a mainframe computer, one or more networked computers, a mobile computer, a personal computer, a laptop computer, a handheld computer, a digital assistant, a digital tablet, or any other processor-based computing device. In addition to having one or more respective processors 119, 126, 152, 166, the respective pharmacy management system 102, service provider computer 104, POS system 106, and third-party computer 108 may each further include one or more respective memories 112, 128, 150, 168, one or more respective input/output (I/O) interfaces 114, 130, 154, 170, and one or more respective network interfaces 116, 132, 156, 172. The respective memories 112, 128, 150, 168 may store respective data files 118, 134, 164, 176 and various program modules, such as a respective operating system (OS) 120, 136, 158, 174, a respective client and/or host module 122, 140, 162, 180 and a respective database management system (DBMS) 123, 138, 160, 178 for accessing one or more respective databases. The OS 120, 136, 158, 174 may be any operating system known in the art or which may be developed in the future including, but not limited to, Microsoft Windows®, Apple OSX™, Apple iOS™, Google Android™, Linux, Unix, or a mainframe operating system.

The respective I/O interface(s) 114, 130, 154, 170 may facilitate communication between the respective processors 119, 126, 152, 166, and various respective I/O devices, such as a keyboard, mouse, printer, microphone, speaker, monitor, bar code reader/scanner, RFID reader, and the like. The respective network interfaces 116, 132, 156, 172 each may take any of a number of forms, such as a network interface card, a modem, a wireless network card, and the like.

The pharmacy management system 102 may be associated with (e.g., located within and/or providing computing services for) any pharmacy or other product dispensing entity, and may be used to receive product orders from a patient or prescriber, and to generate and transmit healthcare transaction requests to a service provider computer 104 and/or a third-party computer 108 for processing or adjudication, as further described herein. The client module 122 of the pharmacy management system 102 may be an Internet browser or other software, such as a dedicated program, for interacting with the service provider computer 104. For example, a user, such as a consumer, pharmacist, or other pharmacy employee, may utilize the client module 122 in preparing and providing a healthcare transaction request to the service provider computer 104 for processing and/or routing. In addition, a user, such as pharmacist, pharmacy technician, or other pharmacy employee, may utilize the client module 122 to retrieve or otherwise receive data from the service provider computer 104, the POS system 106, and/or the third-party computer 108.

The service provider computer 104 may be configured for receiving, processing, and fulfilling requests from the pharmacy related to benefits and/or discount transactions, and/or for performing pre-and-post edit (PPE) processing. The service provider computer 104 may also be operative to configure and/or communicate a notification message to the pharmacy management system 102 and/or the POS system 106. To do so, the service provider computer 104 may communicate directly with the POS system 106, or indirectly with the POS system 106 via the pharmacy management system 102.

According to an example embodiment, the service provider computer 104 may include, but is not limited to, one or more “switches” or “switch providers” performing routing and processing of healthcare transactions, such as eligibility verification requests, predetermination of benefits transactions, healthcare claim transactions, prescription claim or billing requests, healthcare order transactions, or e-prescription transactions (i.e., electronic prescription order transaction, e-script, or e-prescription), between healthcare providers (e.g., prescribers, hospitals, etc.), pharmacies, payors/claims processors, and/or other service providers. For example, the service provider computer 104 may route healthcare transactions, such as a predetermination of benefits transaction, healthcare claim transaction, prescription claim or billing request, healthcare order transaction, or e-prescription transaction (i.e., electronic prescription order transaction, e-script, or e-prescription), communicated from the pharmacy management system 102 to a third-party computer 108, such as a pharmacy benefits manager (PBM), a healthcare insurer, a Medicare payor, other governmental payor, or other third-party insurance payor. The service provider computer 104 may include, but is not limited to, any suitable processor-driven device that is configured for receiving, processing, and fulfilling the healthcare transactions from the pharmacy management system 102 relating to prescription information including, but not limited to, medications, medication identifiers (e.g., medication name(s), National Drug Code(s) (NDC) codes, RxNorm medication identifiers, etc.), quantity of medication to be dispensed, patient identifier information (i.e., patient name, gender, date of birth, residence address, contact information, etc.). Any number of pharmacy management systems 102, POS systems 106, and/or third-party computers 108 may be in communication with the service provider computers 104 as desired in various example embodiments.

The service provider computer 104 and its associated DBMS 138 may be operable to access one or more databases, such as a data storage device 142, for storing and/or retrieving, for example, healthcare transaction information (e.g., prescription claim transaction data), supplemental claim information, claim routing information. According to one example embodiment, the data files 134 of the service provider computer 104 may also store routing tables for determining where to direct the subsequent transmission of a received healthcare claim or request. In one or more example embodiments of the disclosure the data storage device 142, may also include, but are not limited to, one or more patient files 144 and one or more notification files 146.

The patient information files 144 may include, without limitation, patient data, such as a patient identifier (e.g., patient social security number, a subset of the patient social security number, a health insurance claim number (HICN), cardholder ID, etc.), a patient first and last name, a patient gender, a patient date of birth, a patient address (street address, city, state, and zip/postal code), a patient phone number, and/or an email address. The patient information files 144 may also include a message ID and or number associated with a notification message communicated to the patient. The message ID and/or number may also be associated with a patient response to the notification message. In one example embodiment, the message ID and/or number may be used to determine if a patient has received the notification message and/or if the patient has responded to the notification message. The patient information files 144 may also include patient eligibility information, such as, for example, an eligibility group, an eligibility type, an eligibility initiation, an eligibility termination, and the like. In one example embodiment, the patient eligibility information may be used to determine if a patient is eligible to receive the notification message.

The notification files 146 may include, without limitation, one or more previously communicated notification messages and/or one or more patient responses to the communicated notification message. In certain example embodiments, the notification files 146 may be organized by the message ID or number that may be assigned by the service provider during the processing of a healthcare transaction. In one example embodiment, the message ID and/or number may be used to determine if a patient has received the notification message and/or if the patient has responded to, as well as the patient's response to, the notification message. Alternatively, the notification files 146 may be organized by a patient identifier.

The host module 140 of the service provider computer 104 may therefore initiate, receive, process, and respond to claims or requests from the respective client module 122 of a pharmacy management system 102 and/or a POS system 106, and may further initiate, receive, process, and respond to claims or requests from third-party payor systems and/or third-party computers 108.

The PPE module 148 may be operable to perform one or more pre-edits on a received healthcare transaction, such as predetermination of benefits transactions, healthcare claim transactions, prescription claim or billing requests, healthcare order transactions, or e-prescription transactions (i.e., electronic prescription order transactions, e-scripts, or e-prescriptions), prior to routing or otherwise communicating the received healthcare transaction to a suitable third-party computer 108. Additionally, the PPE module 148 may be operable to perform one or more post-edits on an adjudicated response that is received from a third-party computer 108 for a healthcare transaction prior to routing the adjudicated response to the pharmacy management system 102. A wide variety of different pre-edits and/or post edits may be performed as desired in various example embodiments of the disclosure.

When performing processing on claim transaction information received from a pharmacy management system 102 and/or information received from a POS system 106, the service provider computer 104 may access, or otherwise receive information from, the data storage device 142 and/or the data files 134 in memory 128. The data storage device 142 and/or memory 128 may store, for example, transaction records such as claim transaction data, edits, benefits information, patient/consumer information, and/or notification messaging information associated with the healthcare claim transactions.

It is appreciated that in example embodiments, the data storage device 142 may be provided in part or entirely within the service provider computer 104. In yet other example embodiments, the data storage device 142 may be provided in part or entirely within one or more of the other entities' systems, such as at the pharmacy management system 102 and/or the POS system 106. If the service provider computer 104 includes the data storage device 142, then the data storage device 142 could also be part of the memory 128. Although a single data storage device 142 is referred to herein for simplicity, those of ordinary skill in the art will appreciate that multiple physical and/or logical data storage devices or databases may be used to store the above mentioned data. For security and performance purposes, the service provider computer 104 may have a dedicated connection to the data storage device 142. However, the service provider computer 104 may also communicate with the data storage device 142 via the network 110 shown, or via another network.

In certain example embodiments, the service provider computer 104 may be operable to generate one or more invoices or reports for notification messages communicated to patients, pharmacies (e.g., pharmacy management system 102), POS systems 106, and/or any combination thereof. A wide variety of different types of invoices or reports may be generated as desired in various embodiments of the disclosure. Invoices or reports may be sorted or formatted utilizing a wide variety of different criteria, parameters, and/or techniques. Additionally, the service provider computer 104 may communicate or direct the communication of generated invoices or reports to the pharmacy management system 102 and/or a pharmacy back-office computer for the corporate offices of a pharmacy or pharmacy chain that the pharmacy is a member of and/or one or more other components of the system.

A wide variety of different techniques and/or software programs may be utilized to format a generated invoice and/or report. For example, an invoice or report may be formatted as a comma-separated-value (CSV) file, as a spreadsheet file, as a word processor file, as a text file, etc. Additionally, a wide variety of different communication techniques may be utilized to communicate a report to the recipient, including, but not limited to, electronic transaction requests, email, short message service messaging, other electronic communications, paper mail, etc. An invoice report may be pushed to a recipient by the service provider computer 104, or alternatively pulled from the service provider computer 104 by a recipient submitting a request for one or more invoices or reports. Additionally, in certain example embodiments, a report may be made available for download from an appropriate website or server, such as a website hosted by the service provider computer 104.

With continued reference to FIG. 1, the POS system 106 may be any POS terminal operable for processing purchase transactions, which may typically interface with one or more financial systems for completing sales transactions and with one or more financial instrument processors for completing card-based transactions (e.g., credit card, debit card, stored value card, gift card, etc.). As referenced herein, the POS system 106 may be at or associated with the pharmacy operating the pharmacy management system 102, or may be a POS system 106 at or associated with a different pharmacy or different retailer (which need not be a pharmacy). In some example embodiments, the POS system 106 may be integrated with, and thus, form part of the pharmacy management system 102, according to an example embodiment of the disclosure.

The POS system 106 may additionally include a client module 162, which may include an interface, such as a dedicated program and/or an Internet browser, for interacting with a terminal operator (e.g., pharmacist, store clerk, etc.) to obtain information associated with purchase transactions or message verifications and/or to display or otherwise provide information or messages to the terminal operator. The client module 162 may permit manual entry of obtained information, and retrieval of previously stored information (e.g., previous healthcare transaction information from an associated pharmacy management system 102) or messages (e.g., a message to be presented or verified, as described herein). According to an embodiment, the client module 162 may be used to communicate with (e.g., receive or provide information) the pharmacy management system 102 or the service provider computer 104. For non-real-time communications, the client module 162 may also permit storing message verification information obtained at the POS system 106 for subsequent transmission to one or both of a pharmacy management system 102 or a service provider computer 104. The client module 162 may include a data entry interface to capture an operator's input and/or input from an external device. In addition, the client module 162 may interact with the typical transaction processing program of the POS system 106 for determining when to invoke operations to present or verify messages in accordance with example embodiments of the disclosure.

Moreover, the POS system 106 may further include one or more I/O interfaces 146 that facilitate communication with one or more I/O devices for obtaining purchase information, such as an optical scanner, bar code scanner, RFID reader, magnetic stripe reader, touchscreen, keyboard, keypad, and the like. For example, an I/O device(s) may be used to capture information regarding the purchased product, such as from a bar code on a printed label, a stock keeping unit (SKU), etc. of the product. Likewise, the I/O device may also be used to capture identity or insurance/third-party payor information from the patient. In addition, another I/O device such as a card reader or check scanner may be used to capture payment information from a patient. These example I/O devices may be used to capture purchase information by the POS system 106, which may optionally be communicated to a pharmacy management system 102 and/or service provider computer 104, according to an example embodiment of the disclosure.

In certain example embodiments, the third-party computer 108 may be a claims processor computer configured to process or adjudicate healthcare transactions from the service provider computer 104 or the pharmacy management system 102. The third-party computer 108 may be associated with a PBM, a healthcare insurer, a Medicare payor, a Medicaid payor, another governmental healthcare payor, or other third-party healthcare insurance payor, according to an example embodiment of the disclosure. The host module 180 of the third-party computer 108 may include software, such as a dedicated program, for adjudicating prescription claim requests, and providing adjudication responses for the prescription claim requests.

The network 110 may include any number of telecommunication and/or data networks, whether public, private, or a combination thereof, including a local area network, a wide area network, a publicly switched telephone network (PSTN), an intranet, the Internet, intermediate handheld data transfer devices, and/or any combination thereof and may be wired and/or wireless. The network 110 may also allow for real-time, off-line, and/or batch transactions to be transmitted between the pharmacy management system 102, the service provider computer 104, the POS system 106, and the third-party computer 108. Due to network connectivity, various methodologies as described herein may be practiced in the context of distributed computing environments. Although the system 100 is shown for simplicity as including one intervening network 110, it is to be understood that any other network configuration is possible. For example, an intervening network 110 may include a plurality of networks, each with devices such as gateways and routers, for providing connectivity between or among networks 110. Instead of, or in addition to, a network 110, dedicated communication links may be used to connect the various devices in accordance with the example embodiment disclosure. For example, the service provider computer 104 may form the basis of the network 110 that interconnects the pharmacy management system 102, the POS system 106, and the third-party computer 108.

Generally, each of the memories and data storage devices, such as the memories 112, 128, 152, 166 the data storage device 142, and/or any other memory and data storage device, can store data and information for subsequent retrieval. In this manner, the system 100 can store various received or collected information in memory or a database associated with one or more pharmacy management systems 102, service provider computers 104, POS systems 106, and/or third-party computers 108. The memories and databases can be in communication with each other and/or other databases, such as a centralized database, or other types of data storage devices. In some example embodiments, when needed, data or information stored in a memory or database may be transmitted to a centralized database capable of receiving data, information, or data records from more than one database or other data storage device. In other example embodiments, the databases shown can be integrated or distributed into any number of databases or other data storage devices. In one example embodiment, for security, the service provider computer 104 may have a dedicated connection to the data storage device 142; though, in other example embodiments, the service provider computer 104, or another entity, may communicate with the data storage device 142 via a network, such as network 110.

Suitable processors, such as the processors 119, 126, 152, 166 of the pharmacy management system 102, the service provider computer 104, the POS system 106, and/or those of the third-party computer 108, respectively, may include one or more microprocessors, application specific integrated circuits (ASICs), and/or state machines. Example processors can be those provided by Intel Corporation (Santa Clara, Calif.), AMD Corporation (Sunnyvale, Calif.), and Motorola Corporation (Schaumburg, Ill.). Such processors include, or may be in communication with media, for example computer-readable media, which stores instructions that, when executed by the processor, cause the processor to perform the elements described herein. Embodiments of computer-readable media include, but are not limited to, an electronic, optical, magnetic, or other storage or transmission device capable of providing a processor with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer processor, including a router, private or public network, or other transmission device or channel, both wired and wireless. The instructions may include code from any computer-programming language, including, for example, C, C++, C#, Visual Basic, Java, Python, Perl, and JavaScript. Furthermore, any of the processors may operate any operating system capable of supporting locally executed applications, client-server based applications, and/or browser or browser-enabled applications.

The system 100 shown in and described with respect to FIG. 1 is provided by way of example only. Numerous other operating environments, system architectures, and/or device configurations are possible in various embodiments of the disclosure. Other system embodiments can include fewer or greater numbers of components and may incorporate some or all of the functionality described with respect to the system components shown in FIG. 1. For instance, in one example embodiment, the service provider computer 104 (or the pharmacy management system 102, POS system 106, or third-party computer 108) may be implemented as a specialized processing machine that includes hardware and/or software for performing the methods described herein. In addition, the processor and/or processing capabilities of the service provider computer 104 may be implemented as part of the pharmacy management system 102, the POS system 106, the third-party computer 108, or any combination or portion thereof. Accordingly, embodiments of the disclosure should not be construed as being limited to any particular operating environment, system architecture, or device configuration.

Operational Overview

Certain portions of the exemplary methods below will be described with reference to determining and communicating notifications messages for a patient reminder and/or patient services that may be available for a patient as part of the processing of a healthcare transaction. While the methods described below are described with reference to a prescription claim or billing request, each form of a healthcare transaction, such as a predetermination of benefits transaction, healthcare claim transaction, prescription claim or billing request, healthcare order transaction, or e-prescription transaction (i.e., electronic prescription order transaction, e-script, or e-prescription), should be individually read as being used in the methods described below. In addition, while certain methods below are described with reference to the notification message being an influenza reminder, this is also for example only and all other notification message types should be individually read as being used in the methods below.

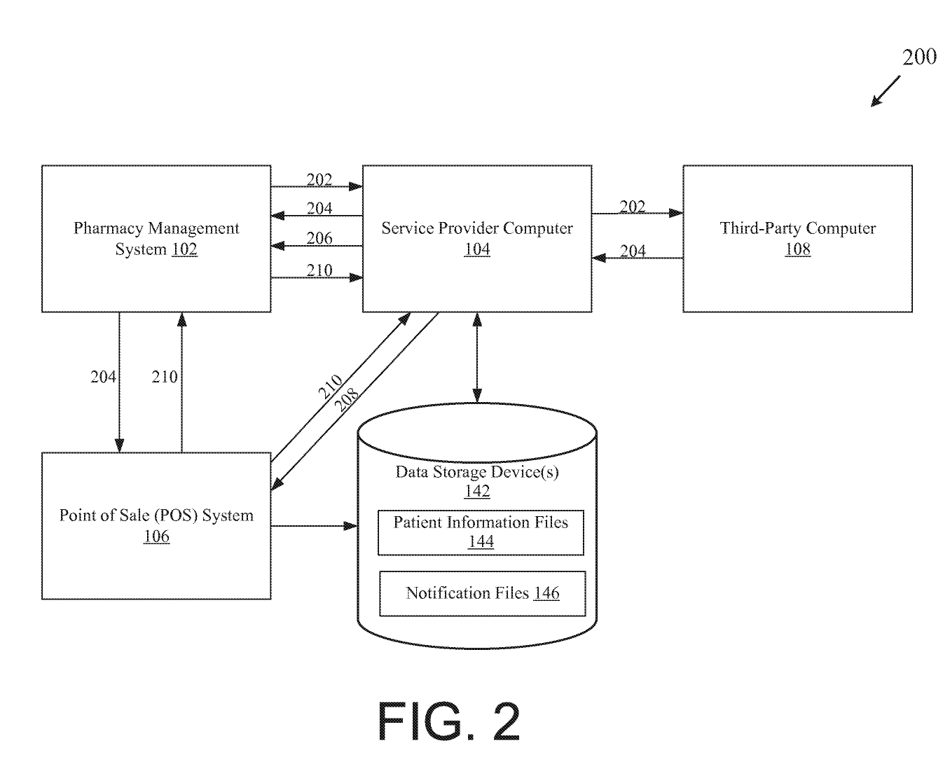

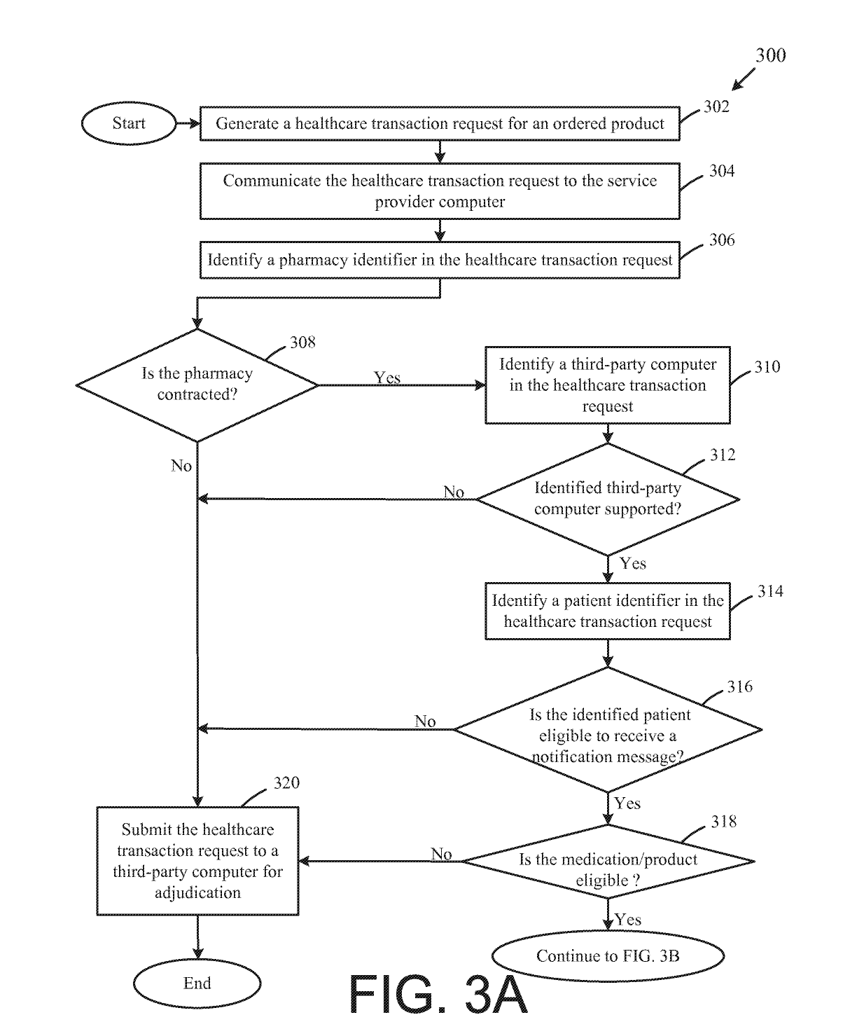

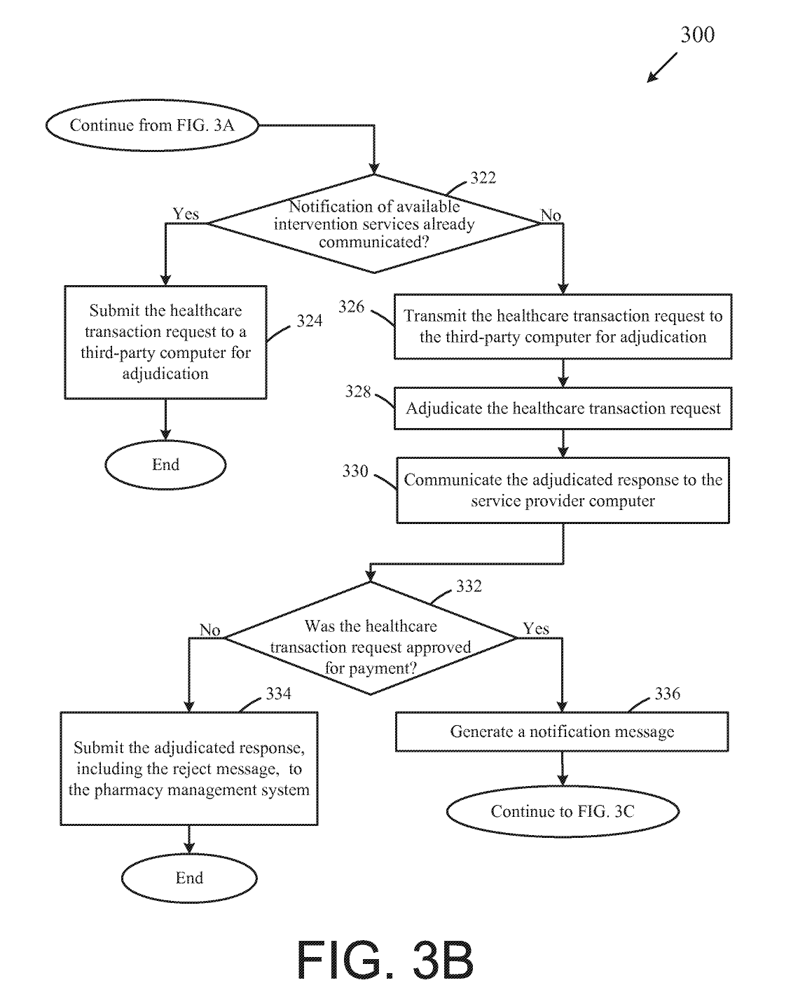

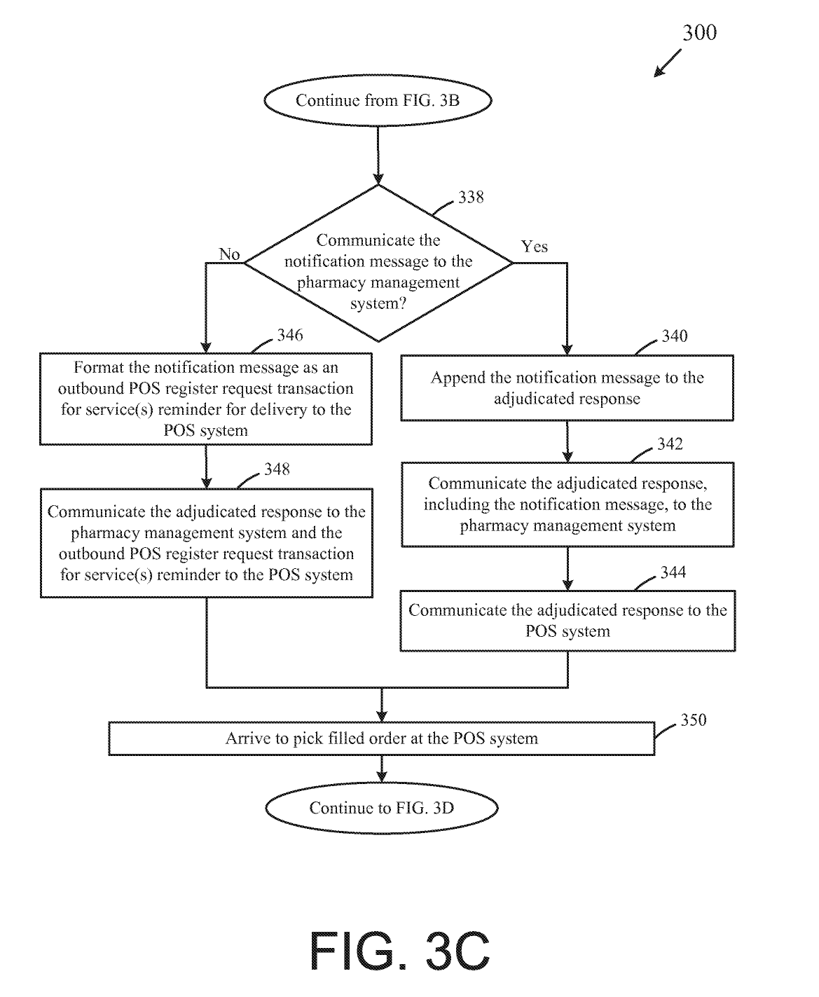

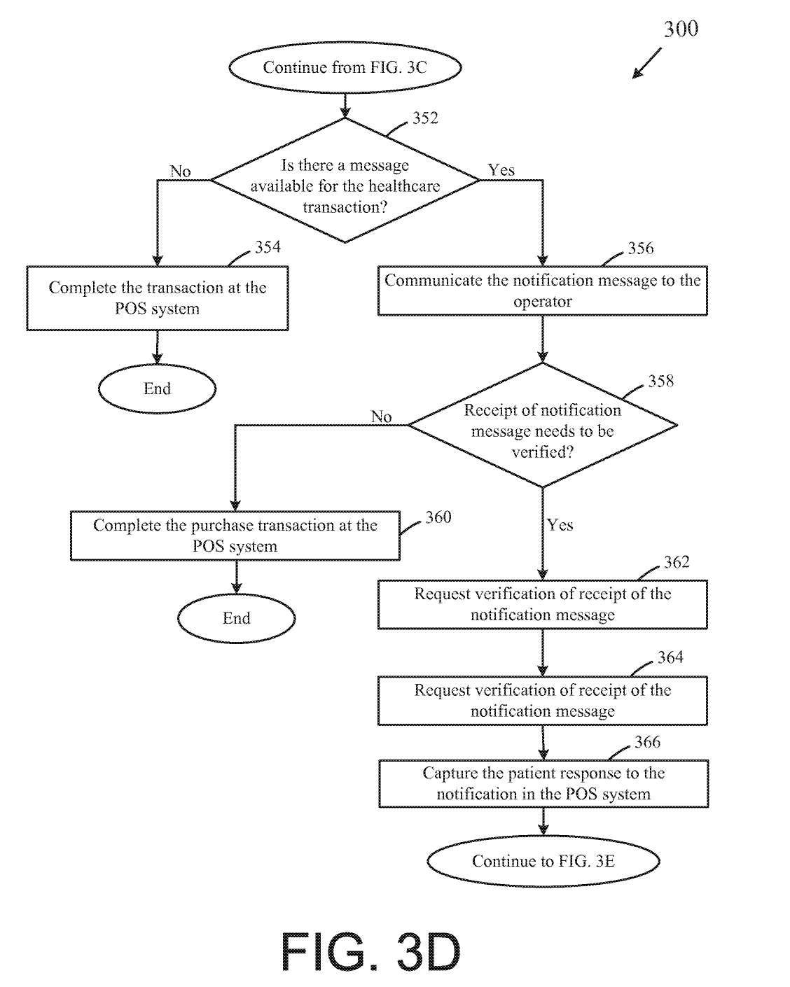

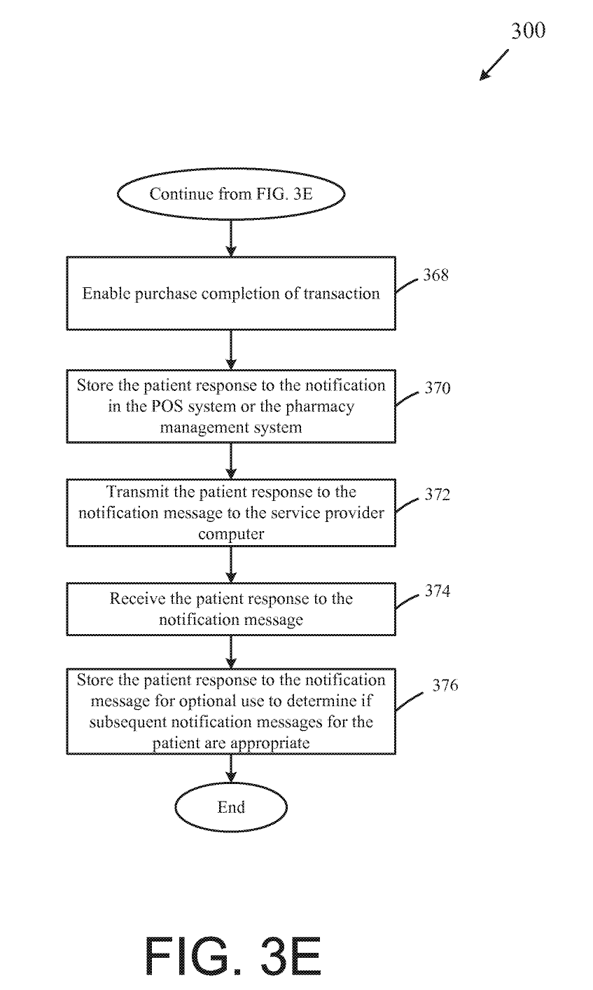

FIG. 2 illustrates an example block diagram for accessing, determining, and/or communicating notifications messages that can include a patient reminder and/or a notification of patient services that may be available for a patient as part of the processing of a healthcare transaction, according to one example embodiment of the disclosure. FIGS. 3A-E illustrate an example method 300 for accessing, determining, and/or communicating notifications messages that can include a patient reminder and/or notification of patient services that may be available for a patient as part of the processing of a healthcare transaction submitted by, for example, the pharmacy via the pharmacy management system 102, according to an example embodiment of the disclosure. The block diagram 200 of FIG. 2 will be discussed in conjunction with the method 300 of FIGS. 3A-E.

Referring now to FIGS. 1, 2, and 3A-E the exemplary method 300 begins at the START step and continues to step 302, where a pharmacist or pharmacy technician may use the pharmacy management system 102 to generate a healthcare transaction request 202 for the ordered product. The healthcare transaction may be in the form of a prescription claim request that is to be processed or adjudicated by the service provider computer 104 or the third-party computer 108, according to an example embodiment of the disclosure. In one example implementation, the healthcare transaction request 202 may include a pharmacy financial transaction (e.g., a prescription billing request). The healthcare transaction request may be in accordance with a version of the NCPDP Telecommunication Standard, although other standards may be utilized as well including, but not limited to, American National Standards Institute (ANSI) ASC X12N format or the Health Law Seven (HL7) messaging standard. As an example, the healthcare transaction request 202 may include one or more the following information:
Payor ID/Routing Information
   Transaction Payor Identifier(s) that designates a destination of the healthcare transaction 210 (e.g., Banking Identification Number (BIN) Number, BIN Number and Processor Control Number (PCN), or BIN Number and Group ID)
Patient Information
   Name (e.g. Patient Last Name, Patient First Name, etc.)
   Date of Birth of Patient
   Age of Patient
   Patient Gender Code
   Patient Address (e.g. Street Address, City, State/Province, Zip/Postal Code, etc.)
   Patient Contact Information (e.g. patient telephone number, email address, etc.)
   Patient ID or other identifier (e.g., Health Insurance Claim Number (HICN), social security number, etc.)
Insurance/Coverage Information
   Cardholder Name (e.g. Cardholder First Name, Cardholder Last Name)
   Cardholder ID and/or other identifier (e.g. person code)
   Group ID and/or Group Information
   State payor information
Provider Information
   Prescriber Information
   Primary Care Provider ID or other identifier (e.g., National Provider Identifier (NPI) code)
   Primary Care Provider Name (e.g. Last Name, First Name)
   Prescriber ID or other identifier (e.g. NPI code, Drug Enforcement Administration (DEA) number)
   Prescriber Name (e.g. Last Name, First Name)
   Prescriber Contact Information (e.g. Telephone Number)
   Pharmacy or other Healthcare Provider Information (e.g. store name, chain identifier, etc.)
   Pharmacy or other Healthcare Provider ID (e.g. NPI code)
Claim Information
   Drug, service, or product information (e.g. via NDC code or RxNorm code)
   Prescription/Service Reference Number
   Date Prescription Written
   Quantity Dispensed
   Days' Supply
   Diagnosis/Condition
   Pricing information for the drug/service/product (e.g. network price, Usual & Customary price)
   Number of Refills Authorized
   One or more Drug Utilization (DUR) Codes
   Dispense as Written (DAW)/Product Selection Code

At step 304, the pharmacy management system 102 may communicate the healthcare transaction request 202 to the service provider computer 104 via one or more suitable networks 110 (e.g., a wide area network, the Internet, a cellular network, etc.). The service provider computer 104 may generally perform editing, evaluation, processing and/or facilitate processing of the healthcare transaction request 202. As an example, the service provider computer 104 may route, transmit, or otherwise deliver information in the healthcare transaction request 202 to the designated third-party computer 108 as the healthcare transaction request 202 for processing and/or adjudication. The service provider computer 104 may receive a response 204 from a healthcare transaction request 202 (e.g., prescription claim request) that may be an approved response that includes the covered amount, and a patient responsibility amount (e.g., patient co-pay amount or coinsurance amount) if the product of the request is covered, at least in part, by the third-party (e.g., claims processor for an insurance company, PBM, government payer, etc.). Otherwise, the response could also be a rejection response that indicates a denial of coverage by the third-party.

The service provider computer 104 may also perform processing (e.g., pre- or post-edit (PPE) processing) on the healthcare transaction comprising the healthcare transaction request 202 and response. In general, the processing by the service provider computer 104 may include any edits or other evaluation or processing that is performed by the service provider computer 104 prior to submitting the healthcare transaction request to the third-party computer 108 (“pre-adjudication”), or after receiving a response from the third-party computer 108 (“post-adjudication”). The processing may generally be used in correcting, verifying, modifying, or qualifying the healthcare transaction. As an example, pre-adjudication processing by the service provider 104 may include determining whether the information in the included healthcare transaction request 202 is valid according to one or more business rules (e.g., proper format, dosage, days' supply). If the transaction request 202 is valid, then the service provider computer 104 may route, transmit, or otherwise deliver information in request 202 to the designated third-party computer 108, as described herein. On the other hand, an example post-adjudication processing may be used to determine whether a healthcare transaction qualifies for a coupon, discount, or voucher that may be funded by a pharmaceutical manufacturer based upon information included with the healthcare transaction request 202 and/or response 206. If qualified for the coupon, discount, or voucher, the service provider computer 104 may reduce the patient responsibility amount determined by the response, or otherwise convert a denied or rejected claim (based upon response 206) to an approved claim. The pre- and/or post-adjudication processing may also be used to determine whether a notification message is available for the patient, as described herein. These and other types of PPE processing may be available in accordance with example embodiments of the disclosure.

The processing by the service provider computer 104 may, for example, include at step 306 the processing of the healthcare transaction request 202. At step 306, the service provider may identify a pharmacy identifier in the healthcare transaction request 202. In one example, the service provider computer 104 may parse the received healthcare transaction request 202 to identify a pharmacy identifier (i.e., a pharmacy name, NPI number, chain identifier, etc.) in one or more fields of the healthcare transaction request 202.

At step 308, the processing of the healthcare transaction request 202 may include, without limitation, determining whether the pharmacy identified by the pharmacy identifier in the healthcare transaction request 202 is a contracted pharmacy. In one example implementation, a contracted pharmacy may be a pharmacy or group of pharmacies (e.g., pharmacy chain) that has contracted with the service provider associated with the service provider computer 104 to receive a POS register messaging service for the medications and/or products identified/requested in healthcare transactions, and thereby are routed or otherwise communicated to the service provider computer 104. For example, the service provider computer 104 may compare the identified pharmacy identifier (e.g., a pharmacy name, NPI code, pharmacy chain identifier, etc.) to a list of acceptable pharmacy identifiers for those pharmacies that have contracted to receive the POS register messaging service. If a match exists, the pharmacy identified by the pharmacy identifier in the healthcare transaction request 202 (e.g., the pharmacy associated with the pharmacy management system 102) is determined to be contracted, the YES branch is followed, and processing may proceed to step 310. If a match is not identified, the pharmacy identified by the pharmacy identifier in the healthcare transaction request 202 (e.g., the pharmacy associated with the pharmacy management system 102) is not contracted, and the NO branch is followed and processing may proceed to step 320.

At step 310, processing of the healthcare transaction request 202 may further include an identification of a corresponding third-party computer 108. In one example embodiment, the service provider computer 104 may parse the healthcare transaction request 202 to identify at least a benefits provider identifier (e.g., BIN Number, BIN Number and PCN, or BIN Number and Group ID). At step 312, the service provider computer 104 may determine whether the third-party computer 108 is supported by the system described in FIG. 1. In one example, the service provider computer 104 may compare the identified benefits provider identifier to one or more tables within the data storage device 142. The service provider computer 104 may parse the one or more tables within the data storage device 102 to identify whether the benefits provider identifier matches a claims processor or other third party listed in the data storage device 142. If the benefits provider identifier does exist in the data storage device 142, then a match has occurred, the YES branch is followed, and processing may proceed to step 314. If the benefits provider identifier does not exist in the data storage device 142, then a match does not exist, the NO branch is followed, and processing may proceed to step 320.

At step 314, processing of the healthcare transaction request 202 may further include an identification of one or more patient identifiers in the healthcare transaction request 202. In one example, the service provider computer 104 may parse the received healthcare transaction request 202 to identify one or more patient identifiers (e.g., a patient social security number, a subset of the patient social security number, HICN, cardholder ID, a patient first name, patient last name, patient date of birth, patient gender, patient address, patient zip/postal code, etc.).

At step 316, the service provider computer 104 may process the healthcare transaction request 202. In one example, the processing of the healthcare transaction request 202 may include, without limitation, determining whether the identified patient in the healthcare transaction request 202 is eligible to receive a notification message. In one example embodiment, the service provider computer 104 may access the patient information files 144. The patient information files 144 may include at least a patient ID, a message ID and/or number, patient demographics (e.g., patient gender, patient age, patient date of birth, patient street address, patient zip/postal code etc.), an eligibility group, and/or an eligibility type. The service provider computer 104 may compare the identified one or more patient identifiers from the healthcare transaction request 202 to the patient information in the patient information files 144. For example, the service provider computer 104 may parse the patient information files 144 to determine if the identified one or more patient identifiers matches a patient identifier in the files 144. If a match exists, the patient is eligible to receive a notification message, the YES branch is followed, and processing may proceed to step 318. If a match is not identified, the patient is ineligible to receive a notification message, the NO branch is followed, and processing may proceed to step 320.

At step 318, processing of the healthcare transaction request 202 may further include a determination of whether the healthcare transaction request 202 includes a request for an eligible medication/product. In one example embodiment, this determination can be made the service provider computer 104. In one example, an eligible product may include, without limitation, a product for which the service provider computer 104 may determine to correspond with the eligibility group, the eligibility type, and/or the patient eligibility information included in the patient information files 144. In one example, the service provider computer 104 may parse the healthcare transaction request 202 to identify one or more product/medication identifiers (e.g., NDC code, RxNorm code, medication name, etc.). Once a product/medication is identified, the service provider computer 104 may compare the identified product/medication to the information included in the associated patient information file 144 (e.g., the eligibility group, the eligibility type, and/or the patient eligibility information) to determine if a match exists. If a match does not exist, the identified product/medication is a non-eligible product/medication, the NO branch is followed, and processing may proceed to step 320. If a match exists, the identified product/medication is an eligible product/medication, and the YES branch is followed to step 322.

At step 320, the service provider computer 104 may continue processing the healthcare transaction by passing the request 202 to the third-party computer 108 for adjudication. The third-party computer 108 will adjudicate the request 202 and return and adjudicated response to the service provider computer 104. The service provider computer 104 can then transmit the adjudicated response to the pharmacy management system 102 without further POS messaging evaluation. The method may end after step 320.

At step 322, processing of the prescription claim request may further include a determination of whether a notification message reminding the eligible patient of one or more available service(s) has been communicated to the patient. In one example embodiment, the service provider computer 104 may access the patient information files 144. The service provider computer 104 may compare the identified patient identifier to the patient information in the patient information files 144. For example, the service provider computer 104 may parse the patient information files to locate a patient file corresponding to the identified patient identifier. If a match is identified, the service provider computer 104 may further determine whether the patient information files 144 includes information corresponding to the notification message. The determination may, for example, be based upon one or more message ID and/or number, a medication and/or product identifier included in the identified file for the identified patient. Alternatively and/or additionally, the determination may be based upon a corresponding service(s) code or type (e.g., vaccine reminder) included in the identified file associated with notification message. Alternatively and/or additionally, the service provider computer 104 may access the one or more message IDs and/or numbers in the notification files 148 to determine whether a notification message has been communicated to the identified patient. If a notification message has previously been communicated to the patient, then the YES branch is followed and processing may proceed to step 324. If a match does not exist and a notification has not previously been communicated to the pharmacy, then the NO branch is followed and processing may proceed to step 326.

At step 324, the service provider computer 104 may continue processing the healthcare transaction request 202 by passing the request 202 to the third-party computer 108 for adjudication. The third-party computer 108 will adjudicate the request 202 and return the adjudicated response to the service provider computer 104. The service provider computer 104 can then transmit the adjudicated response to the pharmacy management system 102 without further services evaluation. The method may end after step 324.

At step 326, the service provider computer 104 may transmit the healthcare transaction request 202 to the third-party computer 108 via, for example, the network 110 for adjudication. At step 328, the third-party computer 108 may adjudicate the healthcare transaction request 202. At step 330, the third-party computer 108 may communicate an adjudicated response 204 to the service provider computer 104 via, for example, the network 110. The adjudicated response 204 may include, without limitation, a transaction status indicator indicating whether the healthcare transaction request 202 was paid or rejected. In one example implementation, when the healthcare transaction request is paid, the adjudicated response 204 may have a transaction status indicator “P”. If, however, the healthcare transaction request 202 is rejected, the adjudicated response 204 may have a transaction indicator “F”.

In one example, when the adjudicated response 204 includes a transaction status indicator “P”, the adjudicated response 204 may also include, without limitation, one or more fields comprising a patient pay amount field (the patient co-pay) populated with a value returned by the third-party computer 108, an associated dispensed quantity field populated with a submitted quantity to be dispensed on the healthcare transaction request 202 and/or a pharmacy name field populated with a short pharmacy name corresponding to the submitted pharmacy identifier on the healthcare transaction request 202.

If, on the other hand, the adjudicated response 204 includes the transaction status indicator “F”, the adjudicated response 204 may also include, without limitation, one or more fields comprising the patient pay amount field left blank, the associated dispensed quantity field left blank, a reject reason field populated with a reject code (e.g., pricing not available for an identified scenario, reject description, patient not covered, medication not in formulary, or the like), the pharmacy name field is left blank, a reason for service code field populated with a reject error code, and/or a reason for service description field populated with an abbreviated description of the corresponding reason for service code.

At step 332, the service provider computer 104 may determine whether the healthcare transaction request 202 was approved for payment by the third-party computer 108. In one example, the service provider computer 104 may parse the adjudicated response 204 to identify the transaction status indicator in the response 204. If the identified transaction status indicator is an “F”, then the NO branch is followed and processing may proceed to step 334. If the identified transaction status indicator is a “P”, then the YES branch is followed and processing may proceed to step 336. If the adjudicated response 204 includes the transaction status indicator “F”, at step 334 the service provider computer 104 may transmit the adjudicated response as part of a reject message 206 to the pharmacy management system 102. The reject message 206 may include one or more rejection reasons corresponding to the healthcare transaction request 202 and/or one or more reject codes in the adjudicated response 204. The method may end after step 334. Alternatively, if the adjudicated response 204 was a rejection/denial, the process may proceed to step 336.

In addition, the service provider computer 104 may perform any post-edits on the adjudicated response 204. For example, if the healthcare transaction request 202 was paid or approved by the third-party computer 108 (or in certain alternative embodiments, even if the transaction request 202 was rejected or denied), at step 336, the service provider computer 104 may generate a notification message. The notification message may be virtually any information that needs to be communicated to an operator or individual at the POS system 106 when performing or completing a purchase transaction. As will be described in further detail herein, the notification message may instruct an operator of the point of sale system to perform one of (i) provide healthcare information to the patient when completing the purchase transaction by the point of sale system, (ii) obtain information from the patient when completing the purchase transaction by the point of sale system, or (iii) verify one or more aspects of the filled order for the product when completing the purchase transaction by the point of sale system. For example, the notification message may include, without limitation, a notification to remind the patient and/or patient caregiver that an electronic coupon was applied to the prescription, a notification to remind the patient and/or patient caregiver of an opportunity for a medication intervention, a notification to provide the patient with certain information regarding the requested medication or product and to capture a patient response to the notification message, a notification to remind the patient to obtain a vaccine, such as their annual influenza vaccine or any other type of vaccine that is due or available, a notification to the pharmacy clerk to explain the need for patient consent and capture patient consent on a signature pad communicably coupled to the POS system 106, a request to capture a patient or patient caregiver's identification information (e.g., a driver's license) at the time of purchase.

In one example, the notification message may include a message ID or number that may be used by the POS system 106 to confirm or verify receipt of the notification message (or performance of the requested action) by an operator at the POS system 106. In an alternative embodiment, the confirmation may be completed by the selection (e.g., depressing a button on a keyboard/keypad or a virtual button on a touchscreen display). The Message ID or number may be selected by the individual or automatically generated by the pharmacy management system 102. The Message ID or number may be provided to the POS system 106, perhaps in conjunction with the delivery of the notification message and/or as a part of the notification message, to the POS system 106. It will be appreciated that the Message ID or number may be selected to be unique from other Message IDs or numbers associated with other messages, according to an example embodiment of the disclosure. In another example, the service provider computer 104 may automatically select or generate the message ID or number. The generated message ID may be stored in the patient information file 144 and/or the notification files 146 corresponding to the identified patient identifier. The notification message may further include, without limitation, a value, a character string, and/or a message that represents the message type, as described herein.

At step 338, the service provider computer 104 may determine whether to communicate the notification message to the pharmacy management system 102 or to communicate the notification message directly to the POS system 106. If at step 338 the service provider computer 104 determines to communicate the notification message to the pharmacy management system, then at step 340, the service provider 104 may append the adjudicated response 204 with a notification message. In one example, appending the notification message to the adjudicated response 204 may be such that the notification message is a part of the adjudicated response 204. For example, the adjudicated response 204 may be illustrated as:
Service Provider ID=7657657651
Date of Service=Aug. 15, 2013
Prescription/Service Reference Number=123456
Fill Number=00
Message ID=XXXX
Message Type=Influenza Reminder

In an alternative example, appending the notification message may include sending the notification along with or substantially at the same time as the adjudicated response 204 to the pharmacy management system 102 without the notification message actually being made a part of the adjudicated response 204.

At step 342, the service provider computer 104 may communicate the adjudicated response 204 to the pharmacy management system 102. The pharmacy management system 102 may receive the adjudicated response 204 and dispense the medication and/or product. At step 344, the service provider 104 may communicate the notification message appended, for example, in the adjudicated response 204 to the POS system 106. In one example, the client module 122 may communicate the message type to the POS system 106 via the client module 162. The method 300 may continue at step 350.

If, however, at step 338 the service provider computer 104 determines to communicate the notification message directly to the POS system 106, then at step 346 the service provider computer 104 may format for delivery and/or routing to the POS system 106, an outbound POS register request transaction for service(s) reminder 208. The reminder 208 may be communicated in before, after, or in parallel with the adjudicated response 204 to the pharmacy management system 102. The POS register request transaction for services(s) reminder 208 may be a reminder for services similar to the notification message described above. In one example, the adjudicated response 204 communicated to the pharmacy management system 102 and the outbound POS register request transaction for services reminder 208 may be illustrated as:

1. Adjudicated response communicated to the pharmacy management system:
Service Provider ID=7657657651
Date of Service=Aug. 15, 2013
Prescription/Service Reference Number=123456
Fill Number=00
Message ID=XXXX.

2. Outbound POS register request transaction for influenza reminder:
Service Provider ID=7657657651
Date of Service=Aug. 15, 2013
Prescription/Service Reference Number=123456
Fill Number=00
Message ID=XXXX

At step 348, the service provider computer 104 may communicate the adjudicated response 204 to the pharmacy management system 102 and deliver the outbound POS register request transaction for service(s) reminder 208 to the POS system 106. The pharmacy management system 102 may receive the adjudicated response 204 and dispense the medication and/or product, and the POS system 106 may receive outbound POS register request transaction for service(s) reminder 208. The method 300 may continue at step 350

At step 350, a patient may arrive to pick up a filled order for the product at the POS system 106. As an example, the POS system 106 may be located in a pharmacy. The operator of the POS system 106 may obtain the filled order for the patient, perhaps from a pharmacy bin, and may proceed to initiate a purchase transaction for the filled order. To initiate a purchase transaction, the operator of the POS system 106 may obtain information regarding the healthcare transaction for the filled order. For example, the POS system 106 may obtain a local copy of the healthcare transaction information comprising the information from the healthcare transaction request 202 and the adjudicated response 204. The local copy of the healthcare transaction may have been previously provided to the POS system 106 from the pharmacy management system 102. Alternatively, during the purchase transaction process, the POS system 106 may obtain the healthcare transaction information by requesting the information from the pharmacy management system 102.

Once the information regarding the healthcare transaction for the filled order has been identified or obtained by the POS system 106, then the POS system 106 may determine at step 352 whether a notification message is available that is associated with the healthcare transaction. For instance, the operator of the POS system 106 may know that a message is associated with a particular healthcare transaction, and use matching information (e.g., transaction number) to determine whether any notification message is available for a particular healthcare transaction. If no notification message is available, then processing may proceed to step 354, where the operator may be able to complete the purchase transaction at the POS system 106. In completing the purchase transaction, the POS system 106 may determine, based upon the information in the healthcare transaction, an amount payable by the patient, which may correspond to the patient responsibility amount provided by the healthcare transaction. Information regarding received payment from the patient may be recorded by the POS system 106, and the patient may then be provided with the filled order for the medication and/or product. The method may end after step 354.

On the other hand, if at step 352 it is determined that a notification message is available, then the operator of the POS system 106 may be presented with the notification message at step 356. As an example, a user interface of the POS system 106 may display the message to the operator. According to an example embodiment of the disclosure, the notification message may instruct an operator of the POS system 106 to provide healthcare information to the patient when completing the purchase transaction by the POS system 106. As another example, the notification message may instruct the operator to provide a copy of a medication guide or other safety information for a product being purchased to the patient. The operator may then ensure that a copy of the medication guide or other safety information is provided to the patient.

In another example, the notification message may also instruct the operator to remind the patient to obtain a vaccine, such as their annual influenza vaccine or any other type of vaccine that is due and/or available. In yet another example, the notification message may also instruct the operator to provide a copy of a notification regarding any applied coupons, discounts, vouchers, which may have been funded by a pharmaceutical manufacturer or another entity. For instance, a faxed or emailed notification may have previously been provided to the pharmacy from the service provider computer 104 or based upon a direction of the service provider computer 104. It will be appreciated that the pharmaceutical manufacturer or other entity may wish to be identified in the notification to inform the patient that it has funded the applied coupon, discount, or voucher. In another example, the notification message may instruct the operator to provide an intervention service, such as medication therapy management (MTM) services, to the patient. In yet another example, the notification message may instruct the operator to counsel the patient with respect to certain side effects of the drug or product. Accordingly, the operator may discuss the side effects of the drug or product with the patient.

In yet another example, the notification message may instruct an operator of the POS system 106 to obtain patient information from the patient when completing a purchase transaction by the point of sale system. For example, the operator may be requested to obtain demographic information from the patient. As another example, the operator may be requested to obtain certain identification information from the patient, perhaps if a controlled product (e.g., a DEA Class II, III, or IV controlled substance) is being dispensed. Likewise, the operator may be requested to ask the patient whether he/she is taking certain other medications. Accordingly, the operator may communicate with the patient to obtain the requested information.

In a further example, the notification message may instruct an operator to perform one or more activities prior to completing the purchase transaction. As an example, the notification message may instruct an operator to verify or complete one or more aspects of the filled order for the product when completing the purchase transaction by the POS system 106. For example, the notification message may instruct the operator to have a medication reconstituted immediately prior to providing the medication to the patient. Thus, the operator may verify that the medication has been reconstituted. If the medication has not been reconstituted, then the operator may have the medication reconstituted. It will be appreciated that the notification message may instruct the operator to perform these and many other types of activities without departing from example embodiments of the disclosure.

At step 358, the POS system 106 may determine whether the receipt of the notification message or performance of an action requested by the notification message needs to be confirmed or verified. As an example, the notification message may have been delivered to the POS system 106 in conjunction with an indicator (e.g., Confirm=True or False) that specifies whether the notification needs to be confirmed or verified. According to an example embodiment of the disclosure, some notification messages may need to be confirmed based upon regulatory requirements, manufacturer requirements, or other requirements associated with the pharmacy, service provider, or third party (e.g., claims processor). For example, the Food and Drug Administration (FDA) may require that medication guides be provided in accordance with a Risk Evaluation Mitigation Strategy (REMS) for a particular drug or product. Likewise, a pharmaceutical manufacturer funding a coupon, discount, or voucher may require that a notification be provided to the patient when the coupon, discount, or voucher is applied to a healthcare transaction for a product. The notification may alert the patient that a particular pharmaceutical manufacturer has funded the applied coupon, discount, or voucher. If no confirmation or verification is needed, at step 360, then the operator may be able to complete the purchase transaction at the POS system 106, as described herein. The method may end after step 360. On the other hand, if a confirmation or verification is needed in step 358, then processing may proceed to step 362.

At step 362, the POS system 106 may request verification of receipt of the message by the operator, perhaps by a prompt or other indication on a user interface of the POS system 106. The operator may verify receipt of the notification message in a variety of ways. In one example embodiment, the operator may depress one or more predetermined keys, buttons, or virtual buttons on the POS system 106 (e.g., on the keyboard, keypad, touchscreen, or display screen) to verify receipt of the notification message. On the other hand, the operator may also provide a message ID or number to the POS system 106 to verify the receipt of the notification message. As described herein, the message ID or number may be obtained by the operator from the healthcare information that is to be delivered to the patient, may be included as part of the adjudicated response 204 or may be separately transmitted to the POS system 106 and/or the pharmacy management system 102. In another alternative, the message ID or number may be a standard one that is provided and is used for all notifications that desire a verification or confirmation or is a set of numbers/message IDs that may each be used in response to a particular notification message. As an example, if the notification message requested delivery of a medication guide to the patient, then the medication guide may have included the message ID or number. Accordingly, the operator may obtain the message ID or number from the medication guide for entry into the POS system 106. In addition, while the example embodiment above describes the operator of the POS system 106 providing the verification or confirmation, in alternative embodiments, the patient or patient caregiver can key-in, depress, or otherwise provide indication of the verification or confirmation in a manner substantially the same as that discussed above with regard to the operator of the POS system 106.

At step 364, the POS system 106 may receive verification or confirmation of the notification message. As described above, the verification may be based upon one or more predetermined keys or buttons being depressed by an operator or another individual at the POS system 106. Alternatively, if the POS system 106 received a message ID or number, perhaps from the pharmacy management system 102 or the service provider computer 104, then POS system 106 may perform the verification or confirmation based upon the message ID or number received from the operator or individual at the POS system 106. As an example, the POS system 106 may have previously received the message ID or number in conjunction with receiving the notification message. Thus, the correct message ID or number may be stored locally at the POS system 106. In another example, the POS system 106 may communicate with pharmacy management system 102 or the service provider computer 104 that created the message ID or number, or which may otherwise have access to the correct message ID or number. In either of these scenarios, the POS system 106 can validate the message ID or number received from the operator or individual at the POS system 106 using either local information or network communications with the pharmacy management system 102 or the service provider computer 104.

Furthermore, at step 366, the POS system may also capture a patient's response to the notification message. For example, if the notification message delivered to the POS system 106 is for the pharmacy clerk to remind the patient to obtain their annual influenza vaccine, the patient may respond by indicating that they have already received their influenza vaccine, or they are not interested in receiving the influenza vaccine, or they would like to receive the influenza vaccine. In another example, the interface of the POS system 106 may present the pharmacy clerk on the user interface of the POS system, one or more check boxes corresponding to one or more possible patient responses to the notification message. In another example, the pharmacy clerk may enter the patient's response on the POS system 106 interface in text by depressing one or more keys or buttons on the POS system 106.

At step 368, the purchase transaction may be enabled for completion. In completing the purchase transaction, the POS system 106 may determine, based upon the information in the healthcare transaction, an amount payable by the patient, which may correspond to the patient responsibility amount provided by the healthcare transaction information. Information regarding any received payment from the patient may be recorded by the POS system 106, and the patient may then be provided with the filled order for the product.

At step 370, the POS system 106 may facilitate storage of the patient's response captured at step 366. Alternatively, the POS system 106 may communicate the patient's response captured at step 366 to the pharmacy management system 102 and the pharmacy management system may facilitate storage of the patient's response captured at step 362. At step 372, the POS system 106 may transmit the patient's response to the notification message to the service provider computer 104. In one example, the POS system 106 may transmit a POS register response 210. The POS register response 210 may, for example, transmit the following information to the service provider computer 104:
I. Service Provider ID=7657657651
II. Date of Service=Aug. 15, 2013
III. Prescription/Service Reference Number=123456
IV. Fill Number=00
V. Message ID=XXXX
VI. Message Date=Aug. 16, 2013
VII. Message Type=Influenza Reminder
VIII. Message Type Response=No
IX. Message verification=Confirm

In one example implementation, the POS system 106 may communicate the POS register response 210 to the service provider computer 104 at the time the patient's response is captured. Alternatively, the patient's response may be stored by the POS system 106, and a batch of POS register responses may be communicated to the service provider computer 104. In yet another alternative, the POS system 106 may communicate the POS register response 210 to the pharmacy management system 102, and the pharmacy management system may communicate the POS register response 210 to the service provider computer 104.

At step 374, the service provider computer 104 may receive the POS register response 210. At step 376, the service provider computer 104 may capture and facilitate storage of the information included in the POS register response 210. In one example, the service provider computer 104 may parse the POS register response 210 to identify the message ID. The service provider computer 104 may compare the message ID to previously generated message IDs to identify a patient corresponding to the transaction. For example, as described herein, the service provider computer 104 may compare the identified message ID to the patient information files 144 to identify a corresponding message ID. The service provider computer 104 may capture the message date, message type, and message type response information from the POS register response 210 and facilitate storage of the captured information in the identified patient information file 144. Alternatively and/or additionally, the service provider computer may access the notification files 146 and compare the identified message ID to identify a corresponding message ID. The service provider computer 104 may capture the message date, message type, and message type response information from the POS register response 210 and facilitate storage of the captured information in the identified notification file 144. The service provider computer 104 may utilize the captured information to determine whether a similar notification message should be generated and communicated to the pharmacy management system 102 and/or the POS system 106 during the processing of subsequent healthcare transactions. For example, during the processing of a subsequent healthcare transaction, the service provider computer 104 may identify a patient identifier. The service provider computer 104 may access the patient information files 144 and determine that a notification message for an influenza reminder was previously communicated to the patient. The service provider computer 104 may also identify that that the response to the notification message was that the patient was not interested at that time to receive the influenza vaccine nor had the patient previously received the influenza vaccine. The service provider therefore, may determine to communicate another influenza reminder message to the patient with the subsequent healthcare transaction.

In one example, the service provider computer 104 may generate a similar notification message similar to a notification message previously communicated to the patient after a set time period has elapsed. For example, similar notification messages may be communicated to the patient once a month, bi-monthly, once a quarter, annually, etc. Additionally and/or alternatively, a notification messages may only be communicated to the patient during a specific time period. For example, an influenza reminder may only be communicated to a patient during a flu season, for example, between the months of September and March. Therefore, if the service provider computer 104 processes a subsequent healthcare transaction in the month of April, the service provider computer 104 may determine that a notification message corresponding to an influenza reminder is not necessary at this time. The method end after step 376.

Accordingly, example embodiments disclosed herein can provide the technical effects of creating a system and methods that provide a way to determine and communicate notification messages, such as an influenza vaccine reminder, that may be available for a patient and to assist in the reporting and storage of documentation associated with communicated notification messages as part of the processing of a healthcare transaction.

While the exemplary embodiments described herein disclose certain steps occurring at the service provider computer 104, in alternative embodiments those steps described with reference to FIGS. 1-3E may alternately be completed at the pharmacy management system 102, the third-party computer 108, a separate processor-driven computing system, a combination of those devices, and/or a combination of those devices along with the service provider computer 104. In those alternate embodiments, certain transmission/receiving steps described above with reference to FIGS. 1-3E may be omitted while others may be added, as understood by one or ordinary skill in the art. The intent being that in alternate embodiments, any of the devices/computers discussed in FIG. 1 are capable of completing any or any part of the methods described with reference to FIGS. 2 and 3A-E.

Various block and/or flow diagrams of systems and methods and/or computer program products according to example embodiments are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, that includes a computer usable medium (e.g., transitory or non-transitory) having a computer-readable program code or program instructions embodied therein, said computer-readable program code adapted to be executed to implement one or more functions specified in the flow diagram step or steps. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram step or steps.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of those set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A computer-implemented method, comprising:
receiving, by one or more computers comprising one or more processors from a pharmacy management system, a prescription claim request, wherein the prescription claim request identifies at least a product identifier for a prescribed product and a patient identifier for a patient prescribed the prescribed product;
determining, by the one or more computers, that a message is available for the patient identified in the prescription claim request;
generating, by the one or more computers, the message available for the patient identified in the prescription claim request, wherein the message requires verification of receipt by an operator of the point of sale system to complete a purchase transaction for a filled order for the product in the prescription claim request;
receiving, by the one or more computers, a patient response to the message, wherein the patient response to the message comprises at least a message ID; and
capturing, by the one or more computers, the patient response to the message.

2. The computer-implemented method of claim 1 further comprising:
receiving, by the one or more computers from a third-party computer, an approved adjudicated response for the prescription claim request;
integrating, by the one or more computers, the message to the approved adjudicated response; and
communicating, by the one or more computers, the message to the point of sale system via the pharmacy management system.

3. The computer-implemented method of claim 1 further comprising:
receiving, by the one or more computers from a third-party computer, an approved adjudicated response for the prescription claim request;
generating, by the one or more computers, a point of sale (POS) register request transaction comprising the message corresponding to the prescription claim request;
communicating, by the one or more computers, the approved adjudicated response to the pharmacy management system; and
communicating, by the one or more computers, the POS register request transaction to the point of sale system.

4. The computer-implemented method of claim 3, wherein the prescription claim request further identifies a pharmacy identifier and a third-party identifier corresponding to a claims processor, and wherein determining, responsive to the approved adjudicated response, that at least one message is available for the patient identified in the prescription claim request comprises one or more of: (i) determining whether the product identifier identifies an eligible product, (ii) determining whether the pharmacy identifier identifies an eligible pharmacy, or (iii) determining whether the third-party identifier identifies an eligible claims processor.

5. The computer-implemented method of claim 1, wherein the message comprises at least one of a notification to remind the patient or a patient caregiver that an electronic coupon was applied to the prescription claim request, a notification to remind the patient or patient caregiver of an opportunity for a medication intervention, a notification to remind the patient to obtain an annual influenza vaccine, a notification to the operator of the point of sale system to explain the need for a patient consent, or a request to capture a patient or patient caregivers identification information at the time of purchase.

6. The computer-implemented method of claim 1, wherein the patient response comprises at least a patient response captured at the point of sale system.

7. The computer-implemented method of claim 1 further comprising:
accessing, by the one or more computers, a patient information file corresponding to the patient identifier, wherein the patient information file comprises one or more message types available to the patient identified in the prescription claim request.

8. The computer-implemented method of claim 7, wherein the one or more message types available to the patient identified in the prescription claim request may indicate whether a message corresponding to a message type has been previously communicated to the patient identified in the prescription claim request.

9. The computer-implemented method of claim 8, wherein if a message corresponding to a message type has been previously communicated to the patient in the prescription claim request, determining whether the message is available for re-communication to the patient identified in the prescription claim request.

10. The computer-implemented method of claim 1, wherein the operator of the point of sale system verifies receipt of the message by providing a unique message ID to the point of sale system.

11. A system comprising:
at least one memory operable to store computer-executable instructions; and
at least one processor configured to access the at least one memory and execute the computer-executable instructions to:
receive, from a pharmacy management system, a prescription claim request, wherein the prescription claim request identifies at least a product identifier for a prescribed product and a patient identifier for a patient prescribed the prescribed product;
determine that a message is available for the patient identified in the prescription claim request;
generate the message available for the patient identified in the prescription claim request, wherein the message requires verification of receipt by an operator of the point of sale system to complete a purchase transaction for a filled order for the product in the prescription claim request;
receive a patient response to the message, wherein the patient response to the message comprises at least a message ID; and
capture the patient response to the message.

12. The system of claim 11, wherein the at least one or more processors configured are further configured to execute the computer-executable instructions to:
receive, from a third-party computer, an approved adjudicated response for the prescription claim request;
integrate the message to the approved adjudicated response; and
communicate the message to the point of sale system via the pharmacy management system.

13. The system of claim 12, wherein the at least one or more processors configured are further configured to execute the computer-executable instructions to:
receive, from a third-party computer, an approved adjudicated response for the prescription claim request;
generate a point of sale (POS) register request transaction comprising the message corresponding to the prescription claim request;
communicate the approved adjudicated response to the pharmacy management system; and
communicate the POS register request transaction to the point of sale system.

14. The system of claim 13, wherein the prescription claim request further identifies a pharmacy identifier and a third-party identifier corresponding to a claims processor, and wherein determining, responsive to the approved adjudicated response, that at least one message is available for the patient identified in the prescription claim request comprises one or more of: (i) determining whether the product identifier identifies an eligible product, (ii) determining whether the pharmacy identifier identifies an eligible pharmacy, or (iii) determining whether the third-party identifier identifies an eligible claims processor.

15. The system of claim 11, wherein the message comprises at least one of a notification to remind the patient or a patient caregiver that an electronic coupon was applied to the prescription claim request, a notification to remind the patient or patient caregiver of an opportunity for a medication intervention, a notification to remind the patient to obtain an annual influenza vaccine, a notification to the operator of the point of sale system to explain the need for a patient consent, or a request to capture a patient or patient caregivers identification information at the time of purchase.

16. The system of claim 11, wherein the patient response comprises at least a patient response captured at the point of sale system.

17. The system of claim 11, wherein the at least one or more processors configured are further configured to execute the computer-executable instructions to access a patient information file corresponding to the patient identifier, wherein the patient information file comprises one or more message types available to the patient identified in the prescription claim request.

18. The system of claim 11, wherein the one or more message types available to the patient identified in the prescription claim request may indicate whether a message corresponding to a message type has been previously communicated to the patient identified in the prescription claim request.

19. The system of claim 11, wherein if a message corresponding to a message type has been previously communicated to the patient in the prescription claim request, determining whether the message is available for re-communication to the patient identified in the prescription claim request.

20. The system of claim 1, wherein the operator of the point of sale system verifies receipt of the message by providing a unique message ID to the point of sale system.
